(19) United States
(12) Patent Application Publication
(10) Pub. No.: US 2011/0274100 A1
(43) Pub. Date: Nov. 10, 2011

(54) RESERVATION METHOD IN A MESH NETWORK, AND TRANSMISSION METHOD CARRYING OUT SUCH RESERVATION METHOD

(75) Inventor: Theodorus Jacobus Johannes Denteneer, Eindhoven (NL)

(73) Assignee: KONINKLIJKE PHILIPS ELECTRONICS N.V., EINDHOVEN (NL)

(21) Appl. No.: 13/143,447

(22) PCT Filed: Jan. 5, 2010
(86) PCT No.: PCT/IB2010/050026

§ 371 Date: Jul. 6, 2011

(30) Foreign Application Priority Data
Jan. 8, 2009 (EP) 09305015.1

(51) Int. Cl. H04W 72/04; H04W 84/02

(52) U.S. Cl. 370/338

(57) ABSTRACT

The present invention relates to a method for reserving transmission time for transmission between a first mesh station and a second mesh station in a mesh network comprising at least one neighbor station, comprising the following steps: the first mesh station requesting information regarding existing reservations from the second mesh station, —the second mesh station sending an advertisement including its own reservation information as well as reservation information concerning the neighbor station, the first mesh station determining a new reservation based on the received advertisement and on its own reservation information. The invention also relates to a transmission method, carrying out the reservation method herein before described.

### FIELD OF THE INVENTION

The present invention relates to communication in mesh networks. More particularly, the invention relates to reservation of transmission times for such communications.

This invention is, for example, relevant for mesh networks compliant with the IEEE 802.11s mesh standard.

### BACKGROUND OF THE INVENTION

A conventional mesh network differs from centralized network in that, instead of having client stations linked to an access point acting as a master station and thus all being in hearing ranges, radio stations are linked to different mesh access points, which are then linked one to the other. Accordingly, a mesh network may include many radio stations, not all of them being in the hearing range of each other. More precisely, mesh networks sometimes comprise hidden terminals interfering with ongoing transmissions between nodes.

To solve this issue, IEEE 802.11s standard introduces a reservation method, for complementing the simple radio access mechanism. This reservation method utilises a reservation limit so that the amount of time occupied by reserved transmissions may not exceed, at any station, a certain fraction of the total available air time. In the current protocol described in the standard, two mesh stations are allowed to set up a reservation in a mesh network only if the new reservation does not cause the reservation limit, or reservation threshold, to be exceeded in a one hop neighbourhood around the involved stations.

However, in existing implementations of such a method, a station that initiates a new reservation can only verify, during the reservation set up process, this condition for itself and its neighbours, but not for the neighbours of intended receiver(s) of the communication. Consequently, as soon as a receiver received a request to set up a reservation, it must check whether the reservation limit would not be exceeded at any stations in its neighbourhood, and then decide whether the new reservation can be accepted.

Moreover, in current protocols, reservation information fields concerning the amount of reserved air time are coded as 1/16^{th} fraction of the Delivery Traffic Indication Message interval, which appears as being insufficient granularity, or precision, for some applications.

Thus, it appears that current reservation mechanisms lead to long delays before initiating a communication, and to complications in the protocol of reservation set up. Moreover, they offer performances that are sometimes lower than the requirements of some applications.

### SUMMARY OF THE INVENTION

It is an object of the invention to propose a reservation method overcoming at least some of the drawbacks above-mentioned.

More particularly, it is an object of the invention to provide a reservation method that allows verification of the different reservation requirements of the network at the station initiating the transmission.

It is also an object of the invention to propose a method allowing for a better control of the granularity, or precision, of the signalling.

It is also an object of the invention to provide a method compliant with the IEEE 802.11s mesh standard, and more particularly a method that can be implemented in a reservation procedure such as the mesh deterministic access method.

To this end, the present invention proposes a method for reserving transmission time for transmission between a first mesh station and a second mesh station in a mesh network comprising at least one neighbor station, comprising the following steps:
the first mesh station requests information regarding existing reservations from the second mesh station,
the second mesh station sends an advertisement including its own reservation information as well as reservation information concerning the neighbor station,
the first mesh station determines a new reservation based on the received advertisement and on its own reservation information.

This method can be applied in any type of wireless networks, and is not limited to the case where there is only one neighbor station.

As a consequence of the features above-mentioned, in a method according to the invention, each radio station in the mesh includes, in a reservation advertisement provided to other stations, information regarding reservation in its neighbourhood. Thus, the initiating station, when requesting information from the receiving station, obtains all information necessary to guarantee that the intended reservation respects the reservation thresholds in the one-hop neighbourhoods, around itself and around the other mesh stations involved in the reservation. The reservation set-up thus appears as being simpler and less error-prone than the existing ones.

According to one embodiment, the reservation information for the first mesh station, respectively the second, comprises a reservation fraction and/or a reservation threshold, wherein the reservation fraction represents the actual fraction of reserved times at the first, respectively second, mesh station, and the reservation threshold represents the maximum allowed reservation fraction of reserved times at the first, respectively the second, mesh station. In a similar way, the reservation information for the first mesh station, respectively the second, comprises a neighborhood reservation fraction and/or a neighborhood reservation threshold, wherein the neighborhood reservation fraction represents the actual fraction of reserved times in the neighborhood around the first, respectively second, mesh station, and the neighborhood reservation threshold represents the maximum allowed reservation fraction in the neighborhood around the first, respectively the second, mesh station. In other words, the neighborhood reservation fraction and the neighborhood reservation threshold represent the reservation fraction and the reservation threshold of the station in the one hop neighborhood of the second mesh station, wherein the difference between the reservation threshold and the reservation fraction is minimal.

In a particular embodiment, instead of advertising the reservation fraction and the reservation threshold, the reservation advertisement of a mesh station comprises a remaining reservation capacity, corresponding to the difference between these two quantities. Moreover, this quantity is expressed, in an example, in units that relate to the maximum amount of time that can be reserved via one reservation.

In a similar way, the reservation information concerning the neighbor station comprises, in a particular embodiment, a neighborhood remaining reservation capacity, corresponding to the minimum remaining reservation capacity of any station in the one hop neighborhood of the reporting station.

Such a feature makes it possible to reach a better granularity, or precision, in coding the reservation information, because a single piece of information has to be coded, instead of two. It has to be mentioned here that all the features related to the remaining reservation capacity, and the fact of using the difference between the reservation fraction and the reservation threshold, may be used independently from the other features of the invention.

The present invention also relates to a method for transmission between a first mesh station and a second mesh station, in a mesh network comprising at least one neighbor station, comprising the following steps:
the first mesh station determines a new reservation using a method according to one of the preceding claims,
the first mesh station checks whether the new reservation does cause reservation thresholds to be exceeded, and
in case the thresholds are not exceeded, the first station initiates a transmission using this reservation.

These and other aspects of the invention will be apparent from and will be elucidated with reference to the embodiments described hereinafter.

### DETAILED DESCRIPTION OF THE INVENTION

The present invention relates to a reservation method that can be implemented within the frame of a reservation protocol called Mesh Deterministic Access Method (MDA) in a mesh network. An MDA method is based on two-major components: a reservation set-up phase, and an advertisement part.

The reservation set-up part is the part during which an initiating station requests information from the other station, to verify whether this reservation does not cause the reservation threshold determined in the network to be exceeded.

The advertisement part corresponds to the mesh stations advertising their reservation information. This information is regularly transmitted via e.g. beacons or advertisement broadcasts. Additionally, this information is sent via unicast in some specific situations, for example during the initial part of the reservation set up phase, when the initiating station requests information on existing reservations.

Accordingly, the present invention takes place in both components of an MDA method, since it mainly relates to information included in the advertisement, for being used during the reservation set-up phase.

Currently, in existing methods, advertisements contain reservation information as can be seen in table 1 below:

TABLE 1

| | | | | | |
|---|---|---|---|---|---|
| Element | Length | MDA | MDA Access | TX-RX | Interfering |
| ID | | Access | fraction limit | times | times report |
| | | fraction | | report | |

In this information element, the MDA Access Fraction and the MDA Access fraction limit fields contain the reservation information needed to limit the amount of time used for reserved transmissions in the mesh neighborhood. The MDA Access Fraction field contains the Reservation Fraction and represents the fraction of reserved times in the neighborhood around the mesh station. The MDA Access Fraction Limit field contains the reservation threshold and represents the maximum fraction of reserved transmission times allowed at this mesh station.

However, as explained before, such element does not contain information regarding the reservation status of the neighbor stations situated around the station sending the advertisement. Thus, when receiving this, the initiating station does not get enough information for completely determining whether a new reservation respects the occupation requirements of the networks.

Thus, to solve this issue, in a method according to the invention, when a receiving mesh station receives a request from an initiating station, the advertisement element returned by this receiving station contains not only reservation information related to the receiving station, but also to its neighbor stations.

Thus, the advertisement element sent in a method according to the invention is as shown in table 2 below:

TABLE 2

| | | | | | |
|---|---|---|---|---|---|
| Reservation | Reservation | Neighborhood | Neighborhood | . . . | . . . |
| Fraction | Threshold | Reservation | Reservation | | |
| | | Fraction | Threshold | | |

The Reservation Fraction and Reservation Threshold fields contain the same information as in the previous methods.

The Neighborhood Reservation Fraction and Neighborhood Reservation Threshold fields contain the reservation information related to the neighbor stations of the station sending the advertisement.

Indeed, the Neighborhood Reservation Fraction and Neighborhood Reservation Threshold represent the Reservation Fraction and the Reservation Threshold of the station in the one hop neighborhood of the reporting station where Reservation Threshold minus Reservation Fraction is minimal. This neighborhood reservation threshold is thus, for a mesh station, the most critical information of its neighborhood. If this threshold is not exceeded, it means that the reservation threshold is respected at any station in the neighborhood.

The content of the Neighborhood Reservation fraction and the Neighborhood Reservation Threshold fields can easily be calculated at each mesh station, based on the content of the Reservation Threshold and Reservation Fraction fields as received in the advertisement elements of the neighbors stations.

In case all the mesh stations in a mesh network have the same Reservation Threshold, it appears as not necessary to report this threshold. In such a case, the mest stations only report the Neighborhood Reservation Fraction, which means that the Neighborhood Reservation Threshold field shown in the table 2 does not exist. Still in this case, the Neighborhood Reservation Fraction is calculated as the maximum Reservation Fraction reported by any of the neighbor stations in the mesh.

Based on these modifications in the advertisement element, in a method according to the invention the reservation set-up part is as follows, the order of the sequences being exemplary:
the initiating station determines a possible reservation time for future transmission,
the initiating station verifies that the new reservation does not cause the Reservation Threshold to be exceeded for itself or for its neighbors,
the initiating station requests information from a receiving mesh station, and receives an advertisement element as shown in table 2
the initiating station verifies, based on the received elements, that the new reservation does not cause the Reservation Threshold to be exceeded, for the intended received and for the neighbors of this station.
   Accordingly, in this method, the initiating station may perform all the checkings, without having to enquire the intended receiver, which leads to a simpler and quicker protocol than the existing ones.

In case the new reservation determined by the initiating station causes the reservation threshold to be exceeded at any station, then the set-up process is canceled by the initating station.

In a particular embodiment, instead of transmitting the Reservation Fractions and Reservation Thresholds, a mesh station includes, in the advertisement element, the difference between these two quantitites. This difference is known as the spare reservation capacity, or the remaining reservation capacity.

The advertisement element is thus as shown in table 3 below:

TABLE 3

| | | |
|---|---|---|
| Remaining | Neighborhood | . . . |
| Reservation | Remaining | |
| Capacity | Reservation Capacity | |

In such a case, the reservation set-up phase is as follows:
the initiating station determines a possible reservation time for future transmission,
the initiating station verifies that the new reservation does not excced the Remaining Reservation Capacity of itself or any of its neighbors,
the initiating station requests information from a receiving mesh station, and receives an advertisement element as shown in table 3,
the initiating station verifies, based on the received elements, that the new reservation neither exceeds the Remaining Reservation Capacity of the intended receiver, nor the Neighborhood Remaining Reservation Capacity.

Using the Remaining Reservation Capacity makes it possible to improve the granularity, or precision, with which the remaining time left for reservations is expressed.

In existing systems, both the Reservation Threshold and Reservation Fraction are expressed using 4 bits, as 1/16^{th} fractions of some interval of fixed length. Coding this reservation information in this way leads to expressing the remaining reservation capacity of 2/16 times this interval length, since there is an uncertainty of 1/16 for each coded information.

Thus, advertising and coding the remaining reservation capacity decreases the uncertainty because:
if 4 bits are used, the uncertainty goes down to 1/16 times the interval length, and
if 8 bits are used, i.e. the same number of bits as in the existing methods, the uncertainty goes downer to 1/256 times the interval length.

To even better adapt the granularity, or precision, with which the Remaining Reservation Capacity is expressed, it is possible to express it via a maximum amount of time that can be reserved with one reservation. This Remaining Reservation Capacity is expressed as a fraction of a parameter called MESH-RESERVATION-LIMIT.

With such a feature, the remaining reservation capacity field and/or of the neighborhood remaining reservation capacity field contain one octet non-negative integers.

As previously mentioned, all the features related to the use of Remaining Reservation Capacity instead of the Reservation Fraction and the Reservation Threshold can be used independently from other features of the invention.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of mesh networks and which may be used instead of or in addition to features already described herein.

1. A method for reserving transmission time for transmission between a first mesh station and a second mesh station in a mesh network, said second mesh station having at least one neighbor station, the method comprising the following steps:
the first mesh station requesting information regarding existing reservations from the second mesh station,
the second mesh station sending an advertisement including its own reservation information as well as reservation information concerning the neighbor station,
the first mesh station determining a new reservation based on the received advertisement and on its own reservation information.

2. A method as recited in claim 1, wherein the reservation information comprises a reservation fraction and/or a reservation threshold, wherein the reservation fraction represents the actual fraction of reserved times, and the reservation threshold represents the maximum allowed fraction of reserved times.

3. A method as recited in claim 1, wherein the reservation information concerning neighbor stations of the second mesh station comprise at least one of: a neighborhood reservation fraction, a neighborhood reservation threshold.

4. A method as recited in claim 3, wherein the neighborhood reservation fraction and the neighborhood reservation threshold represent the reservation fraction and the reservation threshold of the station in the one hop neighborhood of the second mesh station, wherein the difference between the reservation threshold and the reservation fraction is minimal.

5. A method as recited in claim 1, wherein the reservation information of the first, respectively second, mesh station comprises a remaining reservation capacity, corresponding to the difference between a reservation threshold and a reservation fraction.

6. A method as recited in claim 5, wherein the remaining reservation capacity is expressed as a fraction of the maximum amount of time that can be reserved for one reservation.

7. A method as recited in claim 5, wherein the reservation information concerning the neighbor station comprises a neighborhood remaining reservation capacity, corresponding to the minimum remaining reservation capacity of any station in the one hop neighborhood of the reporting station.

8. A method as recited in claim 1 wherein the advertisement sent by second mesh stations includes one or several fields comprised in the group comprising: a neighborhood reservation fraction field, a neighborhood reservation threshold field, a remaining reservation capacity field, a neighborhood remaining reservation capacity field.

9. A method as recited in claim 7, wherein the length of the remaining reservation capacity field and/or of the neighborhood remaining reservation capacity field is one octet.

10. A method for transmission between a first mesh and a second mesh station in a mesh network comprising at least one neighbor station, comprising the following steps:
the first mesh station determining a new reservation using a method according to one of the preceding claims,
the first mesh station checking whether the new reservation does cause reservation thresholds to be exceeded, and
in case the thresholds are not exceeded, the first station initiating a transmission using this reservation.
